(19) United States
(12) Patent Application Publication
(10) Pub. No.: US 2024/0301996 A1
(43) Pub. Date: Sep. 12, 2024

(54) METHOD OF DIAGNOSING AND/OR MONITORING A LUBRICANT DISPENSER

(71) Applicants: Paul GRAF, Rimpar (DE); Thomas HAUPT, Burkardroth (DE); Matthias LENHART, Bad Kissingen (DE)

(72) Inventors: Paul GRAF, Rimpar (DE); Thomas HAUPT, Burkardroth (DE); Matthias LENHART, Bad Kissingen (DE)

(21) Appl. No.: 18/444,645

(22) Filed: Feb. 17, 2024

(30) Foreign Application Priority Data
Mar. 9, 2023 (DE) 102023105820.7

(51) Int. Cl. F16N 29/00; F16N 7/14

(52) U.S. Cl. CPC F16N 29/00; F16N 7/14; F16N 2230/02

(57) ABSTRACT

An electromechanically operated lubricant dispenser having a container filled with lubricant and an electromechanical drive detachably connected to the container for conveying lubricant from the container to an outlet is diagnosed by first providing measurement data with the drive or one or several sensors integrated in the drive and/or in the container for one or more detected variables. In addition at least one condition of the lubricant dispenser is determined from the measurement data and finally the measurement data or data generated therefrom is processed as input data by an algorithm trained with methods of machine learning that classifies a condition of the lubricant dispenser on the basis of the input data.

### FIELD OF THE INVENTION

The invention relates to a method of diagnosing and/or monitoring the condition of an electromechanically operated lubricant dispenser.

### BACKGROUND OF THE INVENTION

In such a method
the lubricant dispenser has a container filled with lubricant (reservoir, lubricant container) and a drive detachably connected to the container for conveying lubricant from the container to an outlet,
the drive or one or several in the drive and/or in the container integrated sensors provide measurement data for one or several detected variables, and
a condition of the lubricant dispenser is determined at least from the measurement data.

The lubricant dispenser is used for example for automated lubrication of machines or plant components, such as for example bearings, linear guides, chains or the like. The lubricant dispenser is for example connected to a lubrication point (for example of a bearing) and can dispense lubricant in dependence on the running time of a machine or at predetermined intervals. The reservoir is filled with the lubricant. It is also referred to as lubricant container, cartridge or “LC-unit” (Liquid Container). As lubricants for example greases or oils are used. The container can be detachably and interchangeably connected to a modular unit with the drive, for example through a screw connection, plug-in connection, snap-in connection, bayonet connection or the like. This allows the drive to be used several times and the container to be replaced after being emptied of lubricant or to be replaced by a new, filled container. However, versions in which the container and the drive form an integral unit are also covered.

The drive, also referred to as the drive head, can be an electric motor drive, one or several batteries as energy supply, and optionally a controller for controlling the drive for dispensing the lubricant, the mentioned components being contained as a rule in a housing of the drive.

In a possible embodiment the lubricant container itself is provided with an outlet port for the lubricant and the lubricant is discharged from the container by a piston guided on a spindle, the piston in the lubricant reservoir, i.e. in the LC-unit and is moved in the container for expelling by a spindle that is also a component of the LC-unit. The drive is connected as a drive head with the LC-unit to the output shaft of the motor connected with the spindle. Control is effected by a controller in the drive that for example has an electronic circuit board that optionally has an actuating element, for example a T-connector, a button, and/or several optical displays, for example a screen or a LCD display and/or several LED's. Such an embodiment is known, for example, from U.S. Pat. No. 9,458,964. The actuating device sets the settings for the lubricant dispensing, for example running times, dispensing intervals etc.

In an alternative embodiment the lubricant reservoir (i.e. neither the LC-unit) nor the drive itself is a so-called feed unit equipped with or connected to an outlet, i.e. the feed unit is connected to pump lubricant from the reservoir to the outlet, i.e. the delivery unit delivers lubricant in the manner of a pump from the reservoir to the outlet. Also in this case is the drive or pump is equipped with a controller holding the various parameters for operation, for example dispensing time, dispensing intervals or the like. One such embodiment is for example is known from U.S. Pat. No. 7,228,941 and from US 2022/0112981.

There is always the possibility that the lubricant dispenser, for example whose drive is equipped with a communication device via a wired or preferably wireless link of the lubricant dispenser with an external device, for example a terminal (smartphone, tablet, laptop or computer). Thus creates the option that settings on the lubricant dispenser can be from or transferred to an external device using an external device and/or information.

The lubricant dispenser can serve for example in industrial systems for controlled and/or regular lubrication of the respective system components, so that both insufficient lubrications as well as overlubrication are prevented. This enables the service life of the machines and for example the service life of bearings to be extended and downtimes to be avoided or reduced.

The lubricant dispenser can be used as a single-point lubrication device or as multiple-point lubricator. A single-point lubricant dispenser typically has its outlet connected directly or via a hose line with the lubrication point. In the case of a multiple-point lubricant dispenser, several outlet ports may be provided or a manifold is connected to one outlet port of the lubricant dispenser via which a single lubricant dispenser is connected to a plurality of lubrication points at different locations via hose lines.

Since the perfect function of a lubricant dispenser is of crucial importance for the operation and the condition of the system or device to be lubricated, there is in principle the need to determine and to monitor the condition of a lubricant dispenser. For this purpose various parameters of the lubricant dispenser can be determined, for example with the aid of sensors.

In U.S. Pat. No. 11,430,326 a device for dispensing lubricant is described that is provided with a communication device, so that status information of the lubricant dispenser can be transmitted to an external device, for example a smartphone or can be queried by an external device. Such status information can concern the remaining battery power, an overload warning of the motor or also information about the remaining lubricant in a lubricant container.

The problem with the diagnosing or monitoring of the condition of a lubricant dispenser is that monitoring interesting conditions cannot be done without further clearly getting individual measured values such as for example a temperature value or a pressure value or also characteristic values of the drive. Here lies the invention.

### OBJECT OF THE INVENTION

The object of invention is to provide a method with which the condition of an electromechanically operated lubricant dispenser can be monitored in an optimized manner reliably and simply. In addition, it is to provide a lubricant dispenser that makes this optimized type of diagnosing or monitoring of the condition possible or is set up for this purpose.

### SUMMARY OF THE INVENTION

To attain this object the invention teaches a generic method of the type described above, but where the measurement data or data generated therefrom are processed as input data by an algorithm trained using machine-learning methods and that classifies a condition of the lubricant dispenser on the basis of the input data. For this purpose, the measurement data can, for example be made available with a predetermined sampling rate as a time series with in each case a plurality of measured values for one or several (physical) detected variables and the time series or data generated therefrom are processed as input data by the algorithm trained with methods of machine learning that classifies a condition of the lubricant dispenser based on the input data. Preferably time series multivariate time series are provided that each contain several detected values.

The measurement data can, for example, be data that is detected using sensors. Alternatively, it can also be data that is provided by the lubricant dispenser or stored within the lubricant dispenser, for example directly by the drive, without the use of separate sensors. As a rule, the measurement data is data from the lubricant dispenser that changes (over time) during operation and is therefore characteristic of the condition of the lubricant dispenser and forms the basis for processing using the algorithm. Optionally, however, in addition to the measurement data, one or more operating parameters of the lubricant dispenser can also be included in the processing with the aid of the algorithm as additional information and taken into account in the classification of the condition, usually in addition to the measurement data that is taken into account for one or more (varying) detected variables.

The detected variables are for example a temperature, a pressure, a current, a voltage and/or a rotational speed made available to, for example detected by one or several sensors or held in a drive or a controller.

The invention proceeds from the discovery that the reliable diagnosing or monitoring of the condition of a lubricant dispenser is of great practical importance, since the faultless operation of the lubricant dispenser also has or can have a significant influence on faultless operation of the system or machine to be lubricated by the lubricant dispenser. In this connection the invention has recognized that the conditions characterizing a lubricant dispenser, for example a normal condition or also the condition of an empty container often only can be determined with difficulty by the measurement and evaluation of individual parameters, since there is not always a direct correlation between the condition of interest and the physical detected variable (for example temperature, pressure, current or voltage). It is therefore not always possible to reliably determine a specific error condition, if a specific parameter exceeds or falls below a predefined limit value. Based on this discovery, the diagnosing or monitoring of the condition of a lubricant dispenser is significantly improved by diagnosing the condition not based solely on the monitoring of measured values or threshold values, but on the recorded data or data or detected values processed and evaluated with a previously trained classification algorithm, i.e. with an algorithm that was previously trained with methods of machine learning and consequently methods of “machine learning.” Consequently in accordance with the invention, the condition classification succeeds on the basis of sensor data recorded by measurement or from the controller for data provided by a “machine learning” algorithm.

In doing so, the invention draws on fundamentally known discoveries and methods of “machine learning” or of condition classification using algorithms. Machine learning is an area of artificial intelligence (AI). These systems recognize correlations and dependencies from a data set in order to subsequently evaluate new data. In machine learning different types are distinguished, namely supervised learning (Supervised Learning), unsupervised learning (Unsupervised Learning), the partially supervised learning (Semisupervised Learning) and the reinforcing learning (Reinforcement Learning). Alternatively as another area of machine learning, deep learning comes into question. In principle all of the methods mentioned can be used in the context of the invention. Preferably the programming of the system takes place with the aid of supervised learning. Such models of supervised learning receive a training-data set that knows the target variable (output). From this data the algorithm is modified by correlations and can classify new data or make predictions. This is the case of a target variable according to the invention since it relates to the condition to be classified. In principle, however, the invention also includes programming or modification of the algorithm using other methods, for example unsupervised learning, semisupervised learning and/or reinforcement learning.

Also in the context with the algorithms used, the invention can draw on known discoveries. This can be in particular for supervised learning the algorithm for example of the type “Random Forest Classifier” or of the type “Support Vector Machine” or of the type “Naive Bayes Classifier” or of the type “k-Nearest Neighbor Classifier” or of type “Long Short Term Memory (LS TM).” As a preferred embodiment in the context of the invention the algorithm of the type “Long Short Term Memory (LS TM)” can be used. Long Short Term Memory algorithms are a type of recurrent networks that in turn derive from neural networks. In neural networks several artificial neurons are coupled together. Recurrent neural networks have compared to a neural network the advantage that the artificial neurons are connected within a layer or to neurons from past layers. This gives the ability to process time series data more effectively. The “Long Short Term Memory” is a variant of the recurrent neural network and it contains a combination of long-and short-term memory. To secure distinctive information about time series one transmits an LSTM in addition to the condition value and also the cell condition. This functions as long-term memory and therefore requires weighting coefficients that decide which information from past time steps are remembered or forgotten. Such an LSTM algorithm is used in the context of the invention particularly preferably. In principle, the invention also covers algorithms (for example classification algorithms) of a different kind. In the context of the invention, the algorithm is used to classify a condition of the lubricant dispenser, so that the algorithm can also be referred to as a classification algorithm. The classification can be carried out directly using the classification algorithm, i.e. the classification algorithm outputs the determined condition. However, the invention also includes embodiments in which classification is performed indirectly via the algorithm, for example by the algorithm first generating a forecast as output, for example predicting a forecast for a specific detected variable. Derived from this knowledge, the condition can then also be determined in a next step, so that a classification of the condition of the lubricant dispenser is also possible in this way.

The basis for condition diagnosing according to the invention using the algorithms that are made available is in particular measurement data recorded as raw data detected in a conventional manner (for example with sensors or made available (for example directly from the drive) and that can be detected for example with sensors) or made available (for example directly from the drive). These raw data can for example be temperature values, pressure values, current values, voltage values and/or speed values or rotational speeds.

Optionally, in addition to the above-described measurement data, the algorithm can process one or more characteristic variables of the lubricant dispenser that do not change for a specific, individual lubricant dispenser during operation, for example the container size and/or the type of lubricant.

The raw data can be preprocessed before the analysis by the algorithm first in a preprocessing stage (“Preprocess”). In doing so it may be for example expedient to preprocess the measurement data/raw data, for example the raw data recorded as time series in a (for example a first preprocessing stage) to scale, to normalize and/or to transform it. This first preprocessing stage can be general preprocessing steps with which in particular the values of the time series or their absolute values are changed, for example normalized. This processing is also referred to as “Data Cleaning.” Alternatively or in addition in this first preprocessing stage there is also a transformation of the measured values into a frequency range, for example by a Fourier transformation. This first preprocessing stage consequently concerns the change of the measured values recorded itself, without thereby as a rule changing the length of the time series/measurement series.

Alternatively or additionally in a (for example second) preprocessing step the raw data or alternatively like the previously process data is normalized in the first preprocessing stage to a uniform vector size for an input vector of the algorithm. Because for flawless transfer of the data to the algorithm is it necessary or advantageous, if the input data form an input vector with uniform vector size. If the data for example is recorded as a multitude of time series are passed as input data to the algorithm, then the time series, with for example different long measurement periods of different length, i.e. a different number of measured values, is normalized to a uniform length. Such normalization to a uniform input vector can be realized in a first embodiment by a length change of one or several time series. This can be realized, if for example a time series is long, in the sense of a reduction by windowing. In the case of a too short time series, an extension by certain values can take place, to obtain a uniform length. Alternatively also the sampling rate can be changed. For this purpose interpoled data points can be added to extend a measurement series. To shorten a measurement series, measurement points could be hidden. Always the standardization of the length of the measurement series and thus the standardization of the vector size for the input vector is in the foreground.

Alternatively or in addition to the change in length of the time series, the normalization of the input vector can be carried out by a data reduction or can be combined with a data reduction.

Data reduction is particularly useful, if the data sets, for example the (multivariate) time series, consist of large data sets or form large data sets. This succeeds preferably by characteristic value extraction that is also referred to as “Feature Extraction” and distinctive points can be extracted from the data and at the same time all information is retained. This is carried out for example by calculating from the data, for example time series, in the framework of “Feature Extraction” in each case several statistical characteristic values (“Features”), the measurement data, for example the respective time series, being used, for example the respective time series, and for example as input vector for the classification algorithm being made available. The statistical characteristic values are, for example, one, several or all of the following characteristic values of a time series for use:
Sum of measured values, Median, Mean, Length, Standard deviation, Variance, Quadratic Mean (RMS), Maximum, Minimum.

A so-called feature vector is composed consequently of several or all of the mentioned statistical characteristic values and forms an input vector for the algorithm or classification algorithm. Alternatively or additionally, other (statistical) parameters can also be used.

As an alternative to the described data reduction by feature extraction a normalization for example by the described length reduction comes into question.

Optionally, the input data from multivariate time series that form the data for various detected variables (features) contain for example temperature, pressure, current, voltage and/or rotational speed. These detected variables can be referred to as “features.” The conditions to be diagnosed are also referred to as “Label.” Experiments and analyses have shown, that often with only few features or detected variables (for example current and rotational speed), a very high accuracy can be achieved and that the analysis of more than two detected variables/features does not necessarily lead to higher accuracy. This also depends on the choice of the respective classification algorithm.

In any case according to the invention training the system is done with the aid of training data. The invention comprises consequently not only the described method of diagnosing and/or monitoring the condition of a lubricant dispenser, but also a method of programming such a lubricant dispenser. This programming method is characterized in that at least training data are made available and that the algorithm is modified with this training data. The reprogramming procedure is consequently also independently protected. In particular, if the supervised programming method is used, the procedure is characterized by the fact that both training data and classified conditions assigned to the training data are provided and that the algorithm is modified with this training data and the respective conditions.

In addition, the invention relates to a lubricant dispenser of the described type that has on the one hand a container or a cartridge and on the other hand a drive, and these two components can either be interchangeably connected to each other or can also form a uniform, nondetachable unit. A component of the drive is in the rule a controller that can have a memory.

For the practical implementation there are various options.

In the first embodiment the lubricator operates autonomously, i.e. the (trained) algorithm is stored in a memory in the lubricator, for example in the drive. The entire evaluation and analysis takes place consequently within the lubricant dispenser that operates autonomously and determines the condition in the described manner and/or monitors. This requires that the lubricant dispenser be equipped with a memory of sufficient size to store the algorithm and the recorded data.

In a second embodiment the classification and optionally also the upstream data processing is outsourced to an external computer, for example a cloud server. This presupposes that the lubricant dispenser can communicate with the computer, i.e. on the one hand can transmit data from the lubricant dispenser to the computer and on the other hand can receive status information from the server after corresponding evaluation. For this purpose, the lubricant dispenser is preferably equipped with a communication device for wireless or wired communication of the lubricant dispenser with the external computer. Here it can be a communication device that is set up for wireless communication, for example via WLAN, Bluetooth or the like. The lubricant dispenser can communicate via a wireless connection for example with a gateway, via which the transmission to the computer, for example the cloud server takes place. The sensor data are consequently recorded by the lubricant dispenser and sent, for example, via a gateway to a cloud server. The transmission can take place, for example, in one or more data frames generated by the lubricant dispenser. The server then performs any required preprocessing and finally the status classification using the algorithm. Subsequently, the condition determined in the manner according to the invention is optionally transferred to the lubricant dispenser or the lubricant system, so that optionally a corresponding reaction can take place. This reaction can be for example the change of the break times or the like. This embodiment has the advantage, that the calculations and memory-intensive evaluations can be relocated to the server. A connection of the lubrication system to a gateway and/or a server is however required.

### BRIEF DESCRIPTION OF THE DRAWING

The above and other objects, features, and advantages will become more readily apparent from the following description, reference being made to the accompanying drawing in which:

FIG. 1 is a vertical section through a lubricant dispenser;

FIG. 2 is a process diagram for monitoring the condition of a lubricant dispenser; and

FIG. 3 is an apparatus according to the invention with a lubricant dispenser and an external computer.

### SPECIFIC DESCRIPTION OF THE INVENTION

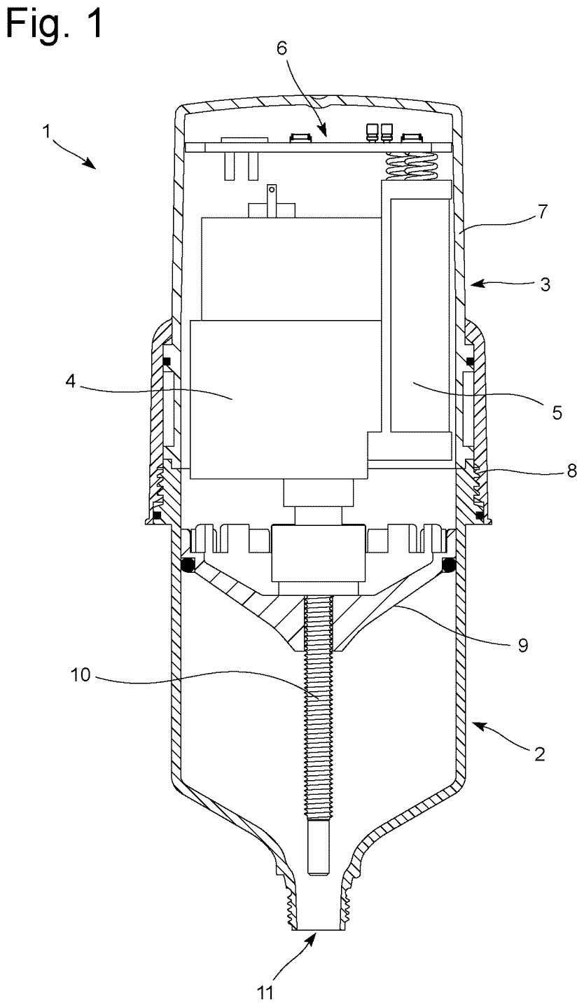

As seen in FIG. 1 a lubricant dispenser 1 of basically known structure has a lubricant-filled container 2 that is also referred to as a cartridge or LC-unit. Furthermore the lubricant dispenser 1 has an electromechanical drive 3 detachably connected to the cartridge. The drive 3, which is also referred to as a drive head, has an electric motor 4 and one or several batteries 5 as energy supply and a controller 6 for operating the drive and dispensing the lubricant. The controller 6 can be a circuit board equipped with suitable electrical motor controls. These components are in a housing 7 of the drive 3, and this housing 7 in turn is connected to the cartridge 2, for example by a screw connection 8, plug-in connection, snap-in connection or bayonet connection. A piston 9 in the cartridge 2 is threaded to a spindle 10 whose rotation moves the piston 9 and thus presses the lubricant out of an outlet port 11 of the cartridge. The drive 3 with the LC unit 2 connects the output shaft of the motor 4 to the spindle 10.

The lubricant dispenser 1, for example the drive 3, can be equipped with one or several (unillustrated) sensors, that detect data for one or several (physical) detected variables. The measurement data can also be supplied directly without separate sensors to the drive 3, for example via the motor 4 or the controller 6. The detected variables are for example motor current, motor voltage, temperature (or a voltage value for the temperature measurement) and/or a pressure and/or the rotational speed of the spindle or of the motor. Optionally, one or more operating parameters (constants for the lubricant dispenser) can be provided in addition to the sensor data that changes during operation, for example the container size and/or the type of lubricant.

Already in the condition of the art it was possible to monitor the detected variables mentioned, in order to determine if necessary a condition of the lubricant dispenser, for example if a current value or a voltage value or a temperature value exceeds a certain limit value or falls therebelow.

In the context of the invention, however no direct evaluation of individual sensed variables takes place in order for example to determine if a sensed value exceeds or falls below a limit. This is because according to the invention a condition classification of the lubricant dispenser is carried out using multivariable data, for example sensor data using machine learning or using a classification algorithm that is trained using methods of machine learning.

For this purpose the measurement data are for example with a predefined sampling rate as time series with in each case a large number of measured values for one or several detected variables made available and the time series or data generated therefrom (as well as any characteristic variables processed as input data by an algorithm characteristic variables) as input data processed by an algorithm that classifies a condition of the lubricant dispenser from the input data. This allows one to determine according to the invention various conditions, for example abnormal conditions like “missing container,” “empty container,” “overcurrent/pressure increase,” “overcurrent/blockage,” and/or “mechanical damage.” Mechanical breakage, for example could be actual physical breakage of the spindle or similar damage.

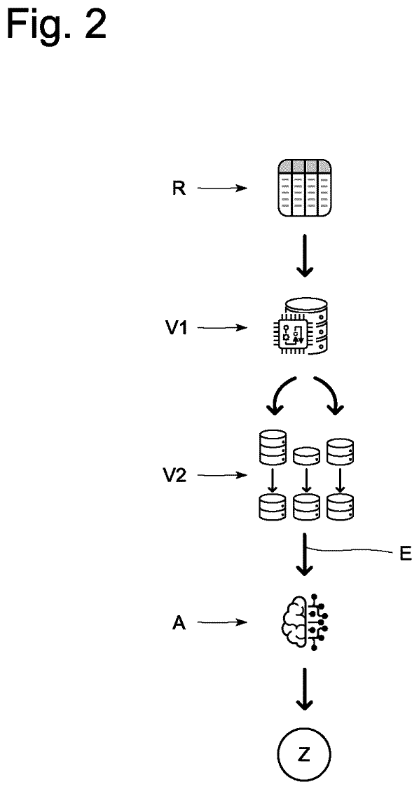

For this purpose the algorithm is first trained with training data and, if the supervised learning method is used, with assigned conditions. In operation, one can then use this trained algorithm to perform condition monitoring in the manner described. For this purpose reference is made to the process diagram according to FIG. 2.

First the raw data R are recorded, for example by time series, and stored. Subsequently the raw data R can optionally be preprocessed in a first preprocessing stage V1. This preprocessing in the first preprocessing stage is also referred to as “data cleaning” of the raw data. The raw data can be scaled, normalized, filtered and/or modified, for example. As a rule, this involves changes to the measured values themselves, for example the absolute values of the measured values within the time series. In the (first) preprocessing stage, individual measurement variables or measurement series, such as voltage or pressure, can also be reduced/deleted.

Alternatively or subsequently, in a preferred embodiment processing of the possibly already prepared measurement data in the first stage V1 can take place in a (second) preprocessing stage V2. This preprocessing stage V2 is used to generate input vectors for the algorithm with a uniform vector size and consequently to standardize the data, for example time series, to a uniform vector size. For example, FIG. 2 schematically indicates that several time series can have different lengths if, for example, dispensing periods of different lengths were recorded. In this preprocessing stage V2, the time series are normalized to a uniform length, for example, and input vectors with a uniform vector size are generated in this way. This is achieved, for example, by reducing or extending the length of a measurement series or by changing the sampling rate. In a particularly preferred embodiment, data reduction takes place during this second preprocessing stage, for example by means of a characteristic value extraction. The length of for example individual time series is not changed or normalized, but rather is extracted from the data, for example time series, in each case several statistical characteristic values are calculated that characterize the respective time series and are then available as input vector for the algorithm A. With the help of this parameter extraction, consequently distinctive points can be extracted from the data and nevertheless all relevant information is retained. The characteristic values may be one or several of the following characteristic values: Sum of the measured values, median, mean, length, standard deviation, variance, root mean square mean (RMS), maximum, minimum. The measurement data reduced in this way are used as input data E for the algorithm A that was previously trained in the way described, so that during operation the classification of conditions Z takes place, i.e. a condition of the lubricant dispenser is determined, for example a normal condition or alternatively also an error condition such as for example the condition “empty container.” It is always advantageous that exactly the same characteristic values and in particular the same number of characteristic values are always generated and processed, so that these characteristic values always form an input vector with a uniform vector size for the algorithm. Consequently, extraction of characteristic values and thus data reduction also leads to a standardization of the vector size, so that in the case of this data reduction via the generation of characteristic values, the previously described change in length of individual time series can also be dispensed with. In any case, it is particularly advantageous to implement at least the second preprocessing stage V2 shown in FIG. 2 to generate a uniform vector size. Preferably, this second preprocessing stage V2 follows the first preprocessing stage V1 described above. However, the invention also includes embodiments in which the first preprocessing stage V1 shown in FIG. 2 is dispensed with, so that the preprocessing stage V2 then forms the first or only preprocessing stage.

In principle there is the possibility of storing the algorithm A and the required methods for the possibly required preprocessing in one or more stages in a memory of the lubricant dispenser itself, so that condition monitoring can take place autonomously within the lubricant dispenser. The status can be displayed then for example via suitable displays or also announced acoustically. You can optionally react to the classified status, for example with an action such as reducing or increasing break times.

Alternatively the information about the condition can also be outputted in another way, for example via a communication device that transmits the determined conditions wirelessly or via wire to a computer, a smartphone, a tablet or the like. Even if the lubricant dispenser can consequently determine the respective conditions autonomously with an algorithm stored in the lubricant dispenser, in principle the possibility of a remote query can be provided.

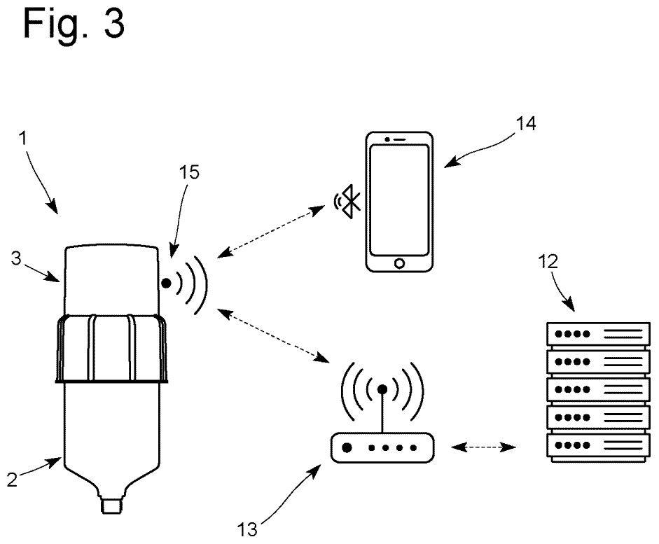

In a preferred embodiment, the shown in FIG. 3, status monitoring or the classification is outsourced to an external computer, for example a cloud server 12. FIG. 3 shows a computer or cloud server 12 where consequently the required methods for the data processing and classification are stored. The measurement data are recorded within the lubricant dispenser 1 and transmitted via suitable interfaces 15 (for example via WLAN) to the cloud server, for example in FIG. 3 also via a gateway 13. The server performs the necessary calculation steps, for example the preprocessing, and finally the status classification. Then the condition determined is transmitted back to the lubrication system, so that within the lubrication system a reaction can take place or the status can be displayed at the lubricant dispenser or can also be queried by another device 14. For this purpose is shown in FIG. 3 for example also the query of the status is via a smartphone 14, for example via a Bluetooth interface 16.

1. A method of diagnosing and/or monitoring an electromechanically operated lubricant dispenser having
a container filled with lubricant and
an electromechanical drive detachably connected to the container for conveying lubricant from the container to an outlet, the method comprising the steps of:
providing measurement data with the drive or one or several sensors integrated in the drive and/or in the container for one or more detected variables;
determining at least one condition of the lubricant dispenser from the measurement data; and
processing the measurement data or data generated therefrom as input data by an algorithm trained with methods of machine learning that classifies a condition of the lubricant dispenser on the basis of the input data.

2. The method according to claim 1, wherein the measurement data are made available at a predetermined sampling rate as time series each comprising a plurality of measured values for one or more detected variables, the method further comprising the step of processing the time series or data generated therefrom as input data by the algorithm.

3. The method according to claim 2, further comprising the step of:
making available as time series multivariate time series available that each contain a plurality of measured values for several detected variables.

4. The method according to claim 3, wherein, as detected variables one, several or all of the detected variables of temperature, pressure, current, voltage and rotational speed are made available.

5. The method according to claim 1, wherein the algorithm processes one or more characteristic variables of the lubricant dispenser in addition to the measurement data.

6. The method according to claim 1, further comprising the step of:
setting up and training the algorithm for the classification of at least of the conditions
“Normal condition,”
“Missing container,”
“Empty container,”
“Excess voltage/pressure,”
“Excess voltage/block,”
“Mechanical damage.”

7. The method according to claim 1, wherein the algorithm is trained with training data.

8. The method according to claim 1, wherein the algorithm is trained according to a method of supervised learning with training data and assigned conditions.

9. The method according to claim 1, wherein the algorithm is of the type “Random Forest Classifier” or “Support Vector Machine” or “Naive Bayes Classifier” or “k-Nearest Neighbor Classifier” or “Long Short Term Memory.”

10. The method according to claim 1, further comprising the step of:
processing measurement data recorded as raw data before analysis by the algorithm in at least one preprocessing stage.

11. The method according to claim 10, further comprising the step of:
scaling, normalizing, converting or filtering the measurement or raw data in the preprocessing stage.

12. The method according to claim 11, wherein the data prepared in a first preprocessing stage are normalized in the preprocessing stage to a uniform vector size for an input vector of the algorithm.

13. The method according to claim 12, wherein the raw data or the preprocessed data are normalized to a uniform vector size by a change in length of one or more time series.

14. The method according to claim 12, wherein the raw data or the processed data are normalized to a uniform vector size by a characteristic value extraction such that in the context of the characteristic value extraction several statistical characteristic values are calculated from the measurement data that characterize the measurement data or the respective time series and form a uniform input vector for the algorithm.

15. The method according to claim 14, further comprising the step of:
determining as statistical characteristic values of one, several or all of the following characteristic values of the measurement data:
Total of the measured values,
Median,
Mean value,
Length,
Standard deviation,
Variance,
Quadratic mean,
Maximum, or
Minimum.

16. A lubricant dispenser with a container filled with lubricant and an exchangeable electromechanical drive connected to the container for carrying out the method according to claim 1.

17. The lubricant dispenser according to claim 16, wherein the drive contains an integral memory in which the algorithm is stored.

18. The lubricant dispenser according to claim 16, wherein the drive has
a communication device for wireless or wired communication of the lubricant dispenser with an external computer 12, and
a memory in the external computer for storing the algorithm.

19. A method of programming a lubricant dispenser according to claim 15, comprising the steps of:
providing training data and
modifying the algorithm with the training data.

20. The method according to claim 19, further comprising the steps of:
making available both training data and classified conditions assigned to the training data available, and
training the algorithm with this training data and the associated conditions using a method of supervised learning.
